(19) United States
(12) Patent Application Publication
(10) Pub. No.: US 2023/0076420 A1
(43) Pub. Date: Mar. 9, 2023

(54) MULTI-PLATFORM KEY RECOVERY FOR TRUSTED CODE

(71) Applicant: R3 Ltd., London (UK)

(72) Inventors: Sotiria Fytraki, London (GB); Katarzyna Streich, London (GB); Roy Hopkins, London (GB)

(21) Appl. No.: 17/929,998

(22) Filed: Sep. 6, 2022

Related U.S. Application Data
(60) Provisional application No. 63/240,897, filed on Sep. 4, 2021.

(51) Int. Cl. H04L 9/08; H04L 9/32

(52) U.S. Cl. CPC H04L 9/0894; H04L 9/0861; H04L 9/3226

(57) ABSTRACT

A system that supports the providing of keys to application enclaves (AEs) that can be used to decrypt data regardless of the CPU that executes an application enclave is provided. A key derivation provider provides a key derivation enclave (KDE) that provides keys to authorized AEs that can used to decrypt data regardless of the CPU upon which an AE is currently executing. The KDE provides the same key to affiliated AEs that may have the same trusted code or different trusted code that is provided by the same author. The KDE generates the same key regardless of the CPU on which it is executing. The KDE and the AEs use attestations to ensure that they are communicating with enclaves that include code that is trusted.

### CROSS-REFERENCE TO RELATED APPLICATION

This application claims priority to U.S. Provisional Application No. 63/240,897 filed on Sep. 4, 2021, which is hereby incorporated by reference in its entirety.

### BACKGROUND

Some computer architectures provide a Trusted Execution Environment (TEE) for execution of trusted code in a tamper-proof environment. The trusted code is stored as an “enclave.” The trusted code and its initial data are stored in memory in encrypted form and decrypted only when retrieved and stored in protected memory (EPC) for execution or use. Untrusted code, which is code other than the trusted code, cannot inspect or interfere with the execution of the trusted code (at least without the permission of the trusted code). The TEE thus protects data at rest (within the TEE), in motion (between the TEE and storage), and during computation (within the TEE). The term “application” refers to a program that may include trusted code and untrusted code. The term “client” refers to code that interacts with the trusted code. The Intel Software Guard Extensions (SGX) and the ARM TrustZone are examples of a TEE. In the following, a TEE is described primarily in the context of SGX.

An enclave includes trusted code and its data and a certificate of the author of the enclave. The certificate is referred to as an Enclave Signature (SIGSTRUCT). The enclave signature includes an enclave measurement, the author's public key, a Security Version Number (ISVSVN) of the enclave, and a Product ID (ISVPRODID) of the enclave. The enclave signature is signed using the author's private key. The enclave measurement is a hash of the trusted code and its initial data. When the code is loaded into protected memory (EPC), the CPU calculates a measurement and stores it in an MRENCLAVE register. If the calculated measurement is not equal to the enclave measurement, the CPU will not allow the enclave to be initialized within the TEE. After the enclave is initialized, the CPU stores a hash of the author's public key in a MRSIGNER register as an identifier of the author. The ISVSVN specifies the security level of the enclave. The ISVPRODID identifies the product the enclave represents. The CPU records both the ISVSVN and ISVPRODID.

A client that is to interact with an enclave (that has been initialized) would typically require the TEE to “attest” to the trusted code and data of the enclave. To provide an attestation to a client that may be executing on platform that is different from the platform of the CPU that is executing the enclave (referred to as “remote” attestation), the TEE generates a “report” that includes the measurement (MRENCLAVE), hash of the author's public key (MRSIGNER), attributes of the enclave, and user data of the enclave. The report is passed to a quoting enclave (QE) to verify and sign the report. When verified, the QE generates a “quote” that includes the report and a signature of the TEE. The quote is then sent to the client.

Upon receiving a quote, the client can verify the signature and if verified, ensure that the report represents the trusted code that the client expects. The signature may be based on an Enhanced Privacy ID (EPID) in which different TEE have different private keys, but signatures based on those private keys can be verified using the same public key. The client may invoke the services of an EPID verification service to verify a signature on a quote.

An enclave that is to interact with another enclave that is executing on the same platform may want the other enclave to attest to its trusted code and data. In such a case, a simplified version of attestation can be used (referred to as “local” attestation). To initiate an attestation, the requesting enclave send its MRENCLAVE measurement to an attesting enclave. The attesting enclave requests the CPU to generate a report destined to the requesting enclave identified by the MRENCLAVE measurement that it received and sends the report to the requesting enclave. The requesting enclave then asks the CPU to verify the report. The attesting enclave may request the requesting enclave to provide an attestation to effect a mutual attestation.

A TEE provides support for an enclave to encrypt data that is to be stored outside of the TEE and to decrypt the encrypted data when it is later retrieved into the TEE. This encrypting and decrypting is referred to as “sealing” and “unsealing.” The TEE generates an encryption key and a decryption key based on a “fused key” that is not known outside of the hardware. The fused key is fused into the CPU hardware during the manufacturing process of the CPU, is not known outside of the CPU not even by the manufacturer, is unique to the CPU, and cannot be accessed except by the hardware. Upon request, the CPU generates a sealing key and unsealing key (e.g., public/private keypair) that is based on the fused key and data associated with the requesting enclave. Thus, each sealing key and unsealing key is unique to the CPU because the fuse keys are unique.

The CPU can generate two types of keys based on the associated data of the enclave that is used when generating the keys. The associated data is the MRENCLAVE (referred to as “sealing to the enclave”) or the combination of the MRSIGNER, ISVSVN, and ISVPRODID (referred to as “sealing to the author”). Data that is sealed to the enclave can only be unsealed by an enclave with the same MRENCLAVE value that is executing on the same CPU (i.e., using the same fused key) that generated the sealing key. Data that is sealed to the author can be unsealed by any enclave (e.g., different trusted code) of the author that has the same ISVPRODID and the same or an earlier ISVSVN (specified in a request to seal or unseal) and that is executing on the same CPU (i.e., using the same fused key) that generated the sealing key. (Note: The CPU will not generate seal-to-the-author keys for an ISVSVN that is greater than the ISVSVN of the enclave, which allows for only backward compatibility of sealing.) The TEE provides a seal application programming interface (API) for sealing data and an unseal API for unsealing data.

This approach to sealing and unsealing data presents problems when an enclave is to execute on a different platform and thus with a different CPU from that used to seal data. The executing of enclaves on different platforms is a common occurrence in a cloud computing environment. In such an environment, there is typically no guarantee on which CPU an enclave will execute. Thus, an enclave that seals data when executing on one platform cannot unseal that data when the enclave is restarted on another platform. Also, if a CPU fails, data sealed using that CPU cannot be unsealed and thus is permanently inaccessible.

### BRIEF DESCRIPTION OF THE DRAWINGS

FIG. 1 is a block diagram that illustrates a scenario in which clients and AEs interact with a KDE.

FIG. 2 is a communications diagram that illustrates communication between a client, a KDE, and an AE.

FIG. 3 is a flow diagram that illustrates the processing of a register AE constraints component of the KDE in some embodiments.

FIG. 4 is a flow diagram that illustrates the processing of a process key request component of the KDE in some embodiments.

FIG. 5 is a flow diagram that illustrates the processing of a retrieve key component of an AE in some embodiments.

FIG. 6 is a flow diagram that illustrates the processing of a check KDE mail-to-self component in some embodiments.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Methods and systems are provided for managing keys of trusted code that can execute on different platforms. In some embodiment, a multi-platform key recovery system includes a key derivation provider (KDP) that provides a key to trusted code of an enclave. The key may be a symmetric key or a public/private keypair. The key derivation provider provides the same key to the trusted code irrespective of the platform (e.g., computer or processor) that executes the trusted code. In addition, the key derivation provider provides the same key to affiliated trusted code. Affiliated trusted code is trusted code that provides the same (or otherwise compatible) evidence of the trusted code. Trusted code of an enclave that requests a key from the KDP may be referred to as an Application Enclave (AE) and AEs with affiliated trusted code may be referred to as affiliated AEs. The evidence (also referred to as constraint) may include one or more of a hash of the trusted code (a measurement), identification of the author of the trusted code (e.g., a hash of a public key of the author), attributes of the trusted code (e.g., product identifier of the trusted code), and so on. The evidence may be considered the same, for example, if the hash of the trusted code is the same or if the author and product identifier are the same. The evidence may be included in a report generated by a TEE of the platform on which the trusted code executes.

In some embodiments, the KDP trusted code of a KDP enclave of the KDP executing in a trusted execution environment generates a master key. Multiple instances of the KDP trusted code may execute simultaneously on different platforms. Each instance of the KDP trusted code generates a master key that is compatible with the master key generated by the other instances (e.g., the same master key). The master keys are compatible in the sense that a key based on the master key that is generated by one instance can be used to decrypted data that is encrypted using a key based on the master key that is generated by another instance.

When an AE requests a key from a KDP, the request includes an attestation that includes a quote and the evidence of its trusted code. Upon receiving a request, the KDP validates the quote and determines whether the AE is authorized to access the services of the KDP by comparing the evidence included in the request to the evidence of authorized AEs. The KDP maintains a store of the evidence of authorized AEs. The evidence may be hardcoded in the AE, received from a server that provisions the KDP, received from a client of the AE, and so on. In some implementations, the KDP is stateless and it does not maintain a store of the evidence of authorized AEs. In such implementations, when an AE requests a key from a KDP it includes a ‘key specification’ as part of the request that defines the parameters of the key it wants access to. The key specification defines what enclaves can access the key (e.g., the MRENCLAVE and/or MRSIGNER values). When the requesting AE meets the requirements in the key specification then the key is derived from a master key using a key derivation function, derived with the key specification itself. In this manner, multiple AEs can all request keys based on the same master key and key specification and, as long as they meet the constraints in the key specification, they can all receive the same key.

When authorized, the KDP generates a key based on its master key and the evidence provided by the AE. Because the key is based on the evidence of the AE, the key is compatible with the key provided to affiliated AEs. Also, because the master key is compatible with the master keys generated by the KDP executing on other platforms, the key is compatible with the key provided by KDPs executing on different platforms. The key may be generated using a key derivation function that based on a hash-based message authentication code such as the IEEE RFC 5869 entitled “HMAC-based Extract-and-Expand Key Derivation Function (HKDF),” which is hereby incorporated by reference. Since HKDF only maintains the master key, and does not maintain any other state, generating the key using HKDF provides additional advantages.

After generating the key, the KDP then responds to the request by sending to the AE the key and an attestation of the KDP. Upon receiving the response, the AE validates the attestation of the KDP. If valid, the AE can use the key to encrypt data that can be decrypted by affiliated AEs and decrypt data the was encrypted by affiliated AEs. All communications between AEs and the KDPs may be encrypted using, for example, a Diffie-Hellman key exchange.

In some embodiments, an AE may store key data that includes the key and the attestation of the KDP in encrypted form externally to the AE by providing the key data to the host of the platform. When the AE is next initialized, it can retrieve and decrypt the key data, validate the attestation of the KDP, and if valid, use the key for encryption and decryption. The storing and retrieving of the key data avoids having to request the key from the KDP. The AE, however, may not be able to load or decrypt the key data. For example, the host may not provide the key data, or the key data may be encrypted using a platform-specific key when the AE was executing on another platform. Even if loaded and decrypted, the attestation of the KDP may not be valid, for example, if a different version of the KDP provided the attestation of the KDP. The key data may be stored using a “mail-to-self” feature provided by the host. The AE may generate and send to the host a mail-to-self that includes the key data that is encrypted using a platform-specific key. When the AE is restarted, it then requests the host to provide the mail-to-self so the key data can be retrieved.

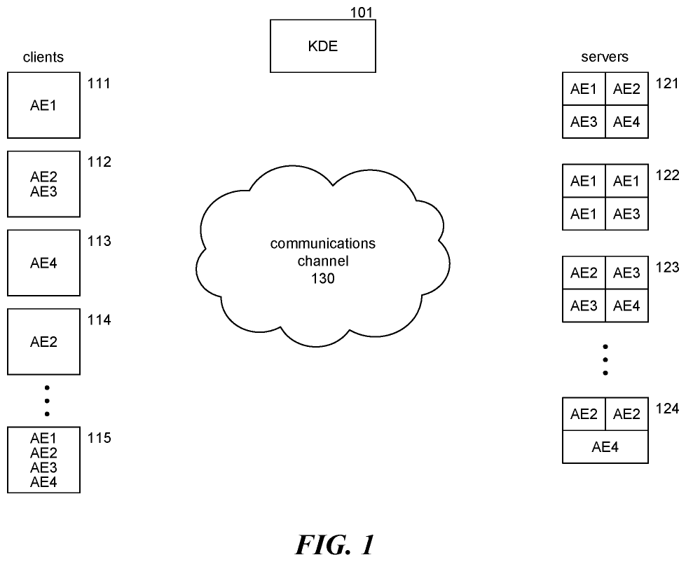

FIG. 1 is a block diagram that illustrates a scenario in which clients and AEs interact with a KDE. A KDE is an enclave with trusted code of a KDP. The diagram includes KDE 101, clients 111-115, and servers 121-124 that communicate via communications channel 130. The servers each host one or more AEs. For example, server 122 hosts three instances of AE1 and one instance of AE3. Each client is a client of one or more AEs. For example, client 112 is a client of AE2 and AE3.

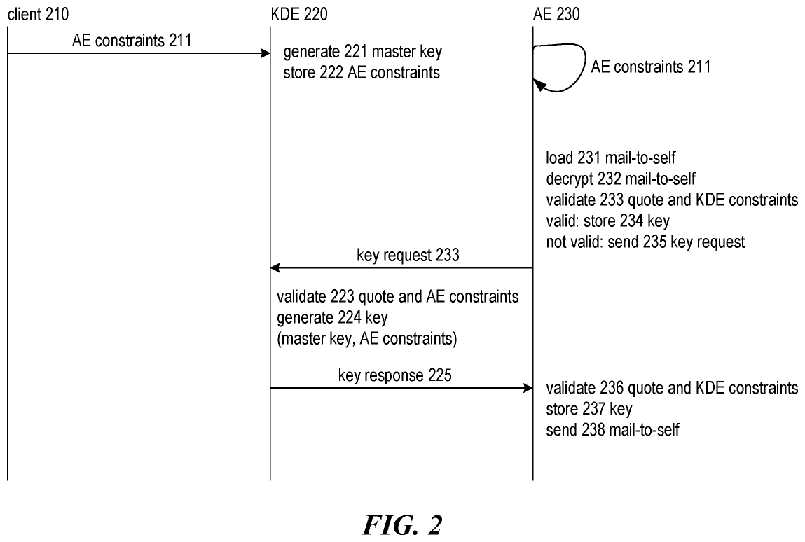

FIG. 2 is a communications diagram that illustrates communication between a client, a KDE and an AE. The KDE 220 initially generates 211 a master key. As discussed above, the KDE 220 can maintain a store of the evidence of authorized AEs. The evidence can be hardcoded in the AE, received from a server that provisions the KDE, received from a client 210 of the AE, and so on. In some embodiments, the 211 AE constraints can be hardcoded in the AE 230 when the AE 230 is compiled. In embodiments where the evidence is received from a client 210 of the AE, the client 210 provisions the AE 230 to the KDE by sending 211 the AE constraints to the KDE. The KDE stores 222 the AE constraints as authorized evidence of an authorized AE.

When the AE is initialized, the AE attempts to load 231 a key and a KDE attestation from a mail-to-self that it previously sent to itself. If loaded, the AE decrypts 232 the mail-to-self using a key that is unique to the CPU. The AE then validates 233 the quote and KDE constraints of the attestation.

In embodiments where the evidence of an authorized AE is hardcoded in the AE, the AE 230 first validates the KDE constraints by, for example, evaluating whether the KDE is signed with the signer's key. This can be done by comparing a hash of the signer's public key, as illustrated below:

conclave {
...
kds {
// This is the constraint of the KDS. Our enclave will refuse
connecting to the KDS URL unless the constraint is satisfied.
// i.e., the KDP enclave is signed with the signer's key indicated
by the constraint below
kdsEnclaveConstraint =
″S:B4CDF6F4FA5B484FCA82292CE340FF305AA294F193821
78BEA759E30E7DCFE2D PROD:1 SEC:STALE″

If valid, the AE stores 234 the key and proceeds to connect to the KDE and encrypt and decrypt data using the key. If the mail-to-self cannot be loaded, decrypted, or the quote or the KDE constraints are not valid, the AE sends 235 a key request to the KDE that includes an AE attestation.

Upon receiving the key request, the KDE validates 223 the quote and the AE constraints of the attestation. The KDE validates the AE constraints by checking that they match authorized AE constraints (e.g., hardcoded in the AE, received from a client, etc.). In some embodiments where the AE constraints are hardcoded in the AE, this can be done by verifying that the AE is signed by a particular signing key for the AE enclave. Alternatively, this can be done by verifying that the AE has a particular code hash. In the first approach, enclaves with different codes will be validated as long as they are signed by the particular signing key. The second approach is more restrictive because it will only validate enclaves having a specific code hash—changes in the underlying code of an enclave will impact the validity of the AE. The two approaches can be hardcoded into the AE as follows:

```
policyConstraint {
  //option1: This is the constraint where we specify the
Dev/Release signing key for the AE enclave.
  // The KDS would only give the shared key to AE enclaves
that match this constraint
constraint=
″S:4924CA3A9C8241A3C0AA1A24A407AA86401D2B79FA9F
F84932DA798A942166D4 PROD:1 SEC:INSECURE″
  // option2: this option is more restrictive: the KDS will only
give the share key to an AE enclave with the given code hash
  useOwnCodeHash = (true|false)  // Optional
useOwnCodeSignerAndProductID = (true|false) // Optional
}
```

If valid, the KDE generates 224 a key (e.g., public/private keypair) that is based on the master key and AE constraints so that key is unique to the AE. The KDE then sends 225 a key response to the AE that includes the key and a KDE attestation.

Upon receiving the response, the AE validates 236 the quote and KDE constraints of the attestation. If valid, the AE stores 237 the key and proceeds to encrypt and decrypt data using the key. The AE also sends 238 a mail-to-itself that includes the key and the KDE attestation and is encrypted with a key that is unique to the CPU.

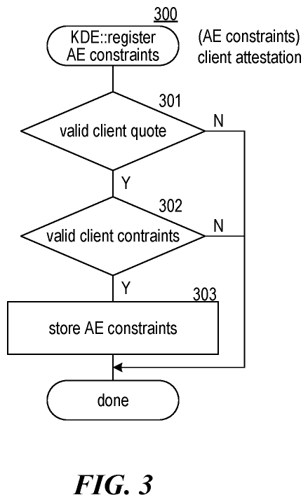

FIG. 3 is a flow diagram that illustrates the processing of a register AE constraints component of the KDE in some embodiments. The register AE constraints component 300 is invoked passing an indication of AE constraints and attestation (e.g., hardcoded in the AE, received from a client, etc.). In decision block 301, the component determines whether the quote is valid. If valid, the component continues at block 302, else the component completes. In decision block 302, the component validates the client constraints. If valid, the component continues at block 303, else the component completes. In block 303, the component stores the AE constraints and then completes. The validation of the attestation may not be needed (e.g., when KDE supports receiving AE constraints from any client).

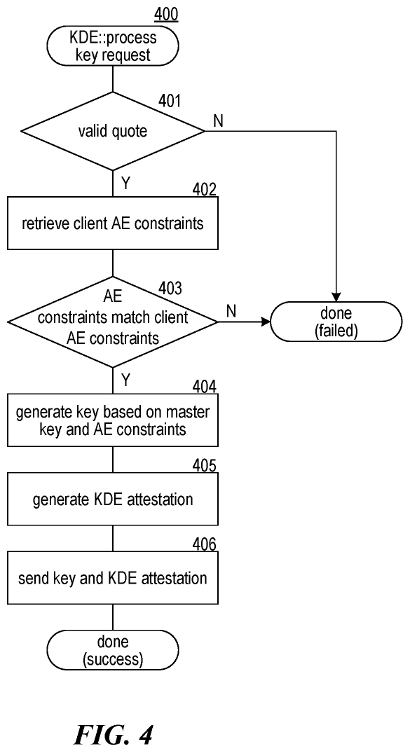

FIG. 4 is a flow diagram that illustrates the processing of a process key request component of the KDE in some embodiments. The process key request component 400 processes the key request received from an AE. In decision block 401, if the quote of the attestation of the key request is valid, then the component continues at block 402, else the component completes indicating that the request cannot be processed. In block 402, the component retrieves the authorized AE constraints that may been hardcoded in the AE, received from one or more clients, and/or received from a server that provisions the KDE. In decision block 403, if the AE constraint of the request matches authorized AE constraints, then the component continues at block 404, else the component completes indicating that the request cannot be processed. In block 404, the component generates a key based on the master key (previously generated for the KDE) and the AE constraints provided in the key request. In block 405, the component generates a KDE attestation (or retrieve one previously generated). In block 406, the component sends a key response to the AE that includes the key and the KDE attestation and then completes indicating success.

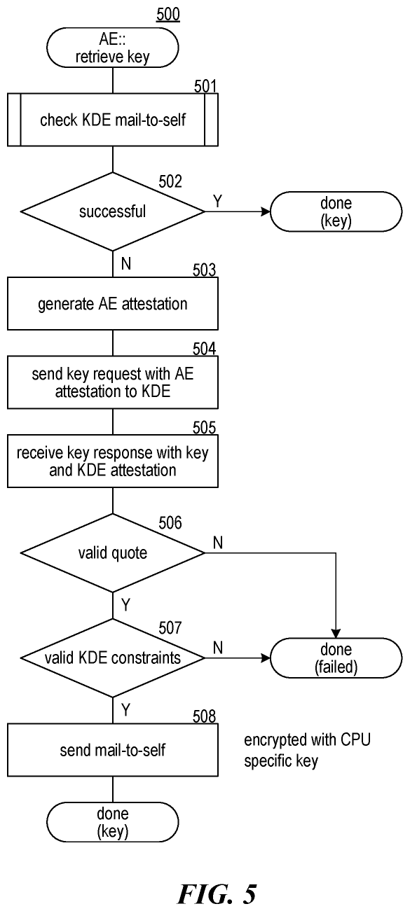

FIG. 5 is a flow diagram that illustrates the processing of a retrieve key component of an AE in some embodiments. The retrieve key component 500 is invoked when the AE is initialized and retrieves a key generated by the KDE. In block 502, the component invokes a check KDE mail-to-self component to determine whether the key is available in the mail-to-self previously sent by the AE. In decision block 502, if the key was successfully retrieved, then the component completes providing the key, else the component continues at block 503. In block 503, the component generates an AE attestation that includes the AE constraints. In block 504, the component sends a key request with the AE attestation to the KDE. In block 505, the component receives a key response with the key and a KDE attestation. In decision block 506, if the quote of the KDE attestation is valid, then the component continues at block 507, else the component completes indicating that the key cannot be retrieved. In decision block 507, the component validates the KDE constraints of the KDE attestation against hardcoded constraints in the data of the AE. If valid, the component continues at block 508, else the component completes indicating that the key cannot be retrieved. In block 508, the component sends a mail-to-self that includes the key and the KDE attestation that is encrypted with a CPU unique key. The component then completes returning the key.

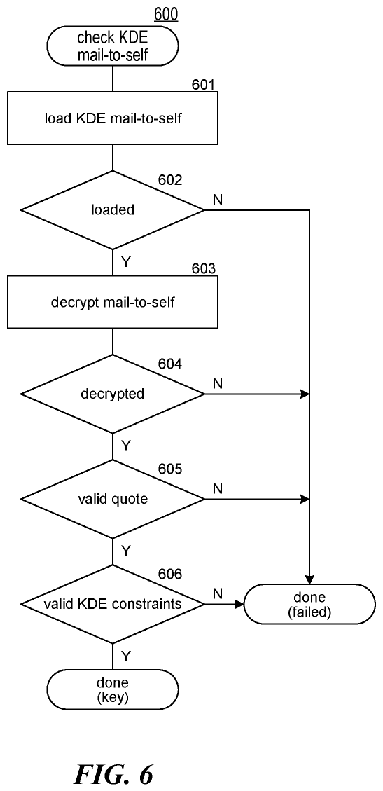

FIG. 6 is a flow diagram that illustrates the processing of a check KDE mail-to-self component in some embodiments. The KDE mail-to-self component 600 determines whether a key can be retrieved from a mail-to-self that the AE previously sent from the CPU upon which it is currently executing. In block 601, the component attempts to load the KDE mail-to-self. In decision block 603, if loaded, then the component continues at block 603, else the component completes indicating failure. In block 603, the component decrypts the mail-to-self. In decision block 604, if the mail-to-self was successfully decrypted, then the component continues at block 605, else the component completes indicating failure. In decision block 605, the component validates the quote of the KDE attestation that was included in the mail-to-self. If valid, the component continues at block 606, else the component completes indicating failure. In decision block 606, the component validates the KDE constraints of the attestation in the mail-to-self. If valid, then the component completes indicating success, else the component completes indicating failure.

The computing systems on which the methods and systems described above may be implemented may include a central processing unit that supports a TEE, input devices, output devices, storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the methods and systems. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys. The computing systems may be servers that are housed in a data center such as a cloud-based data center.

The methods and systems may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the methods and systems may be implemented in hardware using, for example, an application-specific integrated circuit (ASIC) or field programmable gate array (“FPGA”).

The following paragraphs describe various embodiments of aspects of the methods and system described above. An implementation of the methods and system employ any combination of the embodiments. The techniques described below may be performed by a computing device with a processor that executes computer-executable instructions stored on a computer-readable storage medium that implements the methods.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by one or more computing systems for providing a key derivation provider that provides a key to trusted code of an enclave, the method comprising:
generating a master key of the key derivation provider;
receiving from first trusted code of a first enclave a request for a key, the request including evidence of the first trusted code, the first trusted code being executed by a first processor;
determining whether the evidence indicates that the first trusted code is authorized to access the key derivation provider;
generating a key that is based on the master key and the evidence; and
sending to the first trusted code a response to the request, the response including evidence of the trusted code of the key derivation provider and the key,
wherein when second trusted code of a second enclave is executed by a second processor and provides the same evidence, the same key is sent to the second trusted code so that the first trusted code can decrypt data encrypted by the second trusted code and the second trusted code can decrypt data encrypted by the first trusted code.

2. The method of claim 1 wherein the first trusted code is the same as the second trusted code.

3. The method of claim 1 wherein first trusted code is different from the second trusted code.

4. The method of claim 1 wherein the first trusted code has a first author and the second trusted code has a second author and the first author and the second author are the same.

5. The method of claim 1 wherein the determining compares the received evidence to authorized evidence of the first trusted code, wherein the authorized evidence of the first trusted code is hardcoded within the first trusted code, or received from a client of the first trusted code, or received from a provisioning server.

6. The method of claim 1 wherein the determining compares the received evidence to one or more constraints included in a key specification received from the first trusted code.

7. The method of claim 1 wherein the key is generated using a key derivation function based on two or more of: a hash-based message authentication code using the master key, the evidence of the first trusted code, and a key specification of the key being generated.

8. The method of claim 1 wherein the key derivation provider is implemented as trusted code of an enclave.

9. The method of claim 1 wherein the evidence includes a constraint of the trusted code.

10. The method of claim 1 wherein the evidence is included in an attestation generated by the first processor.

11. At least one non-transitory, computer-readable medium carrying instructions, which when executed by at least one data processor, performs operations for providing a key derivation provider that provides a key to trusted code of an enclave, the operations comprising:
generating a master key of the key derivation provider;
receiving from first trusted code of a first enclave a request for a key, the request including evidence of the first trusted code, the first trusted code being executed by a first processor;
determining whether the evidence indicates that the first trusted code is authorized to access the key derivation provider;
generating a key that is based on the master key and the evidence; and
sending to the first trusted code a response to the request, the response including evidence of the trusted code of the key derivation provider and the key,
wherein when second trusted code of a second enclave is executed by a second processor and provides the same evidence, the same key is sent to the second trusted code so that the first trusted code can decrypt data encrypted by the second trusted code and the second trusted code can decrypt data encrypted by the first trusted code.

12. A method performed by one or more computing systems for accessing a key, the method comprising: under control of first trusted code of a first enclave being executed by a first processor,
determining whether an attestation of key data is valid, the key data including a key and an attestation of a key derivation provider, the attestation including a quote and evidence of trusted code of the key derivation provider;
when the attestation is not valid,
sending to trusted code of the key derivation provider a key request that includes an attestation that includes a quote and evidence of the first trusted code;
receiving from the trusted code of the key derivation provider a key and an attestation of the key derivation provider, the attestation including a quote and evidence of trusted code of key derivation provider; and
determining whether the attestation of the key derivation provider is valid.

13. The method of claim 12 further comprising loading the key data that was previously stored by affiliated trusted code that is affiliated with the first trusted code.

14. The method of claim 13 wherein the key data is included in a mail-to-self that the first trusted code sent.

15. The method of claim 14 wherein when the first trusted code is being executed by a processor and the mail-to-self was sent by affiliated trusted code that is affiliated with the first trusted code when the affiliated trusted code was executed by a different processor, proceeding as if the attestation of the key data is not valid.

16. The method of claim 13 further comprising upon determining the that attestation of the key derivation provider is valid, sending a mail-to-self that includes the key and the attestation of the key derivation provider.

17. The method of claim 13 wherein when the key data cannot be loaded, proceeding as if the attestation of the key data is not valid.

18. The method of claim 12 wherein the first trusted code and the trusted code of the key derivation provider execute in a trusted execution environment.

19. The method of claim 12 wherein an attestation is valid when both the quote and the evidence of the attestation are valid.

20. The method of claim 12 wherein the key derivation provider provides the same key and attestation of the key derivation provider to trusted code that is affiliated with the first trusted code.
